(19) United States
(12) Patent Application Publication
(10) Pub. No.: US 2026/0266235 A1
(43) Pub. Date: Sep. 10, 2026

(54) METHOD FOR LIMITING A SUCTION OF OIL INTO AN INTERNAL COMBUSTION ENGINE

(71) Applicant: Schaeffler Technologies AG & Co. KG, Herzogenaurach (DE)

(72) Inventors: Bruno VIALAN, Toulouse (FR); Stéphane ELOY, Toulouse (FR)

(21) Appl. No.: 19/165,950

(22) PCT Filed: May 7, 2024
(86) PCT No.: PCT/EP2024/062521

§ 371 Date: Sep. 16, 2025

(30) Foreign Application Priority Data
May 12, 2023 (FR) FR2304728

(51) Int. Cl. F02D 41/14; F01M 11/10; F02D 41/00; F02D 41/22; F02D 41/38

(52) U.S. Cl. CPC F02D 41/14; F01M 11/10; F02D 41/0007; F02D 41/0055; F02D 41/009; F02D 41/22; F02D 41/38; F02D 2200/101

(57) ABSTRACT

Method for limiting a suction of oil, with the following steps:
a confirmation step (100) in the absence of fuel combustion:
   a) monitoring by measuring time interval durations (T_Seg_Mes_n) between two successive passes through top dead center at the end of compression,
   b) applying a deceleration correction factor (Rn),
   c) comparing measured and corrected interval durations (T_Corr_Seg_Mes_n), and
   d) detecting a measured and corrected interval duration less than the others and storing same,
a step (200) of determining a quantity of oil burned in the engine, with:
   e) determining a gradient (GR) representing a variation in speed of rotation of the engine, and
   f) on the basis of a predetermined map, estimating the quantity of oil burned (Q),
a step (300) of adapting the intake air pressure in the cylinders.

The present disclosure relates to a method for limiting a suction of oil into an internal combustion engine.

### TECHNICAL FIELD

The technical field of the present invention is thus the field of engine control for an internal combustion engine. It relates to an engine comprising a plurality of cylinders. The present disclosure is intended in particular for a motor vehicle or the like (a motorcycle, truck, etc.) but can also be used for another type of vehicle (a boat or other vehicle).

### PRIOR ART

In an internal combustion engine, pistons slide in cylinders and, through a connecting rod/crankshaft system, rotate a flywheel, and this movement is passed on to the wheels of the vehicle in order to move same. The combustions take place in combustion chambers. Each piston forms a partition between the corresponding combustion chamber and a housing in which the connecting rod/crankshaft system moves. This partition must be sealed, firstly so that all of the pressure generated by the combustions can be transferred to the piston, and also to prevent the oil used to lubricate the engine, in particular the connecting rod/crankshaft system, from entering the corresponding combustion chamber.

In order to seal the engine at the piston, that is, between the piston and the cylinder (or sleeve) in which it slides, it is known practice to use annular “seals” known as rings. It is common practice to use three rings: a sealing ring in the middle protected on the combustion chamber side by a ring referred to as the top compression ring, which makes it possible in particular to limit the thermal stress applied to the sealing ring, and on the housing side by an oil control ring or segmentation ring, well known to a person skilled in the art, which limits the quantity of oil that can come into contact with the sealing ring.

In a new engine, the rings usually work perfectly, but as they age, due in particular to the significant stress to which the rings are subjected, sealing problems can occur and oil can then enter a combustion chamber. During an intake phase in a cylinder of a four-stroke engine, reduced pressure is created in said cylinder in order to draw in outside air. If one or more segmentation rings is/are worn or broken or damaged, the reduced pressure prevailing in the corresponding cylinder or cylinders results in suction of the oil present in the housing. This phenomenon is referred to hereinafter in the present disclosure by the expression “suction of oil”. When it burns, this oil can cause uncontrolled emissions. In addition, such combustion also generates unexpected additional power as the combustion of the oil generates unexpected torque. In some cases, oil consumption can result in damage to the engine. It is therefore important to at the very least detect abnormal consumption, and it is preferable to limit and/or eliminate it.

Oil consumption can be detected, for example by monitoring the oil level in the engine. However, such monitoring does not make it possible to identify the piston (or cylinder) affected, and is solely preventive and not curative.

The present disclosure is intended to improve the situation. It therefore aims to provide means for detecting abnormal oil consumption due to combustion in a cylinder, and for limiting this consumption in order to prevent any risk of damage to the engine, if possible.

### SUMMARY

A method is proposed for limiting a suction of oil into an internal combustion engine comprising a plurality of cylinders in each of which a piston slides, following the detection of the presence of said suction of oil.

According to the present disclosure, this method comprises the following steps:
a step of confirming the presence of suction, performed in the absence of fuel combustion, with the following sub-steps:
   a) monitoring by measuring durations of time intervals between two successive passes through top dead center at the end of compression by the pistons in the cylinders,
   b) applying a deceleration correction factor to be applied to the measured interval duration, for each time interval, in order to take into account a mean deceleration of the engine speed,
   c) comparing the measured and corrected interval durations, and
   d) potentially detecting one (or more) measured and corrected interval duration(s) less than the other measured and correct interval durations, and storing the result of the detection,
a step of determining a quantity of oil burned in the engine if in the preceding confirmation step at least one measured and corrected interval duration less than the others has been detected, with the following sub-steps:
   e) determining a gradient representing a variation in speed of rotation of the engine, and
   f) on the basis of said gradient, estimating the quantity of oil burned using a predetermined, stored map,
if applicable, a step of adapting the intake air pressure in the cylinders, during which a variation in said pressure is commanded as a function of the previously determined quantity of oil burned.

In a novel manner, a method is proposed that makes it possible not only to detect oil consumption and, if applicable, determine in which cylinder(s) oil is being burned, but also to take remedial action by limiting oil combustion.

In the method proposed above, the deceleration correction factor to be applied in sub-step b) can for example be determined as a function of the variation in the duration of a time interval from one cycle to another for a cylinder, and of the number of cylinders in the engine.

In a method above, the gradient representing a variation in speed of rotation of the engine in sub-step e) can be a gradient of variation in the duration of the measured and corrected time interval less than the other durations of measured and corrected time intervals.

In a method above, the map in sub-step f) can be produced in advance on an engine of the same type not experiencing suction of oil, in which in a deceleration phase for which no combustion is envisaged, known quantities of fuel per engine cycle are injected and burned at various engine speeds and the influence of this injection and this combustion on the gradient used in step e) is measured.

In a method proposed above, during the adaptation step, provision can be made for example for the variation in the intake air pressure in the cylinders to be commanded by acting on at least one of the following elements of the engine:
air intake butterfly valve, and/or
turbocharger, and/or
exhaust gas recirculation valve.

Provision can be made to incorporate into a method for limiting a suction of oil into an internal combustion engine described above, also in advance, a step of detecting oil combustion and a step of determining a cylinder in which said combustion is taking place. In such a method, provision can be made to implement the following steps for detecting the presence of suction of oil:
a detection step carried out with the following sub-steps:
   i) a first step of monitoring the operating stability of the engine at a first low-load operating point,
   ii) a first step of determining a respective correction factor to be applied, for each cylinder, in order to correct a quantity of fuel injected into said cylinder, with a view to regulating the engine speed at said first operating point,
   iii) a first step of storing the respective correction factors for each cylinder, corresponding to the first operating point,
   iv) a second step of monitoring the operating stability of the engine at a second high-load operating point,
   v) a second step of determining a respective correction factor to be applied, for each cylinder, in order to correct a quantity of fuel injected into said cylinder, with a view to regulating the engine speed at said second operating point,
   vi) a second step of storing the respective correction factors for each cylinder, corresponding to the second operating point,
a step of determining oil combustion in a given cylinder if, for said cylinder, the ratio between a first predetermined correction factor and the correction factor corresponding to the first operating point during the detection step is below a predetermined threshold, while for the same cylinder the ratio between a second predetermined correction factor and the correction factor corresponding to the second operating point during the detection step is within a predetermined interval around 1.

Advantageously, a method above further comprises a warning step when a suction of oil is detected, the cylinder or cylinders affected then advantageously being identified.

According to another aspect, a computer program is proposed comprising instructions for implementing a method as described above when this program is executed by a processor, in particular an electronic control unit of an internal combustion engine.

According to another aspect, a non-transitory computer-readable recording medium is proposed, on which such a program is recorded.

According to another aspect, a control unit configured for managing an internal combustion engine is proposed, comprising means for implementing each of the steps of a method described above.

According to another aspect, a motor vehicle is proposed comprising an internal combustion engine, characterized in that it comprises a control unit according to the preceding paragraph.

### BRIEF DESCRIPTION OF THE DRAWING

Further features, details and advantages will become apparent on reading the detailed description below, and with reference to the appended drawing, in which:

FIG. 1 is a diagram illustrating a deceleration of an engine without oil combustion showing a speed of rotation of the engine and measured then corrected time interval durations, each corresponding to the time elapsed between two successive passes of a piston through top dead center at the end of compression.

FIG. 2 is a diagram corresponding to the diagram in FIG. 1, for a deceleration of an engine with oil combustion in a cylinder.

FIG. 3 is a graph that can be used to determine a quantity of oil burned in the engine in question.

FIG. 4 is a logic diagram for implementing a method for limiting a quantity of oil burned in an engine according to the present disclosure.

FIG. 5 is a logic diagram for implementing a method for detecting and limiting oil burned in an engine according to the present disclosure.

FIG. 6 is a diagram illustrating a closed loop used for detecting oil combustion in an engine as a prior step to the implementation of a method for detecting and limiting oil burned in an engine according to the present disclosure.

FIG. 7 is a diagram comparing a detection step in a cylinder without oil combustion to a cylinder with oil combustion with a view to detection prior to the implementation of a method for detecting and limiting oil burned in an engine according to the present disclosure.

FIG. 8 is a schematic view of a vehicle in which a method for detecting and limiting oil burned in an engine according to the present disclosure can be implemented.

### DESCRIPTION OF THE EMBODIMENTS

The present description is given in relation to an internal combustion engine, of the four-stroke type. As is known to a person skilled in the art, an internal combustion engine comprises one or more cylinders, each containing a combustion chamber. Each combustion chamber is associated with a piston that slides in a back-and-forth movement, passing successively through a top dead center, then a bottom dead center, and so on. Seals, known as rings, make it possible to produce the seal between a piston and the corresponding cylinder and both prevent air or gas escaping from the combustion chamber around the periphery of the piston, and prevent lubricating oil from the engine from entering the corresponding combustion chamber. So-called intake and exhaust valves make it possible to manage the flows toward and away from each combustion chamber respectively and an injector makes it possible to inject fuel into each combustion chamber.

The following description is thus given with respect to a four-stroke engine having a plurality of cylinders; the engine in the example selected has four cylinders. In a four-stroke engine, a complete working cycle takes place over two engine revolutions, i.e. passing through two top dead centers and two bottom dead centers. A complete working cycle therefore includes four operating phases. These phases are known to a person skilled in the art and are therefore described briefly here. A first phase relates to air intake. The piston moves downward in the cylinder (increasing the volume of the chamber in the cylinder). The intake valve is open while the exhaust valve is closed. In the second phase, or compression phase, the piston moves upward and compresses the air (or air/fuel mixture) admitted in the first phase. In order to allow a pressure increase in the cylinder (combustion chamber), the two valves (intake and exhaust) are closed. In the third phase, the fuel is injected and burned and pushes the piston back in a downward movement. The two valves remain closed. Finally, the fourth phase allows the discharge of the burned gases. The piston rises back up in the cylinder and drives the burned gases out through the exhaust valve, which is open, while the other (intake) valve is closed. During an engine cycle, each piston of the engine passes through a top dead center at the end of the compression cycle.

When the engine is new, the injectors have similar features so that they inject similar quantities of fuel for one and the same injection setpoint. In addition, it is assumed that the piston rings are completely tight and no oil is entering a combustion chamber.

However, when the engine ages, oil can enter one or more combustion chambers by suction. This can cause uncontrolled emission of gas and the combustion of oil produces drive torque that is not taken into account by the engine management system.

Such suction of oil must therefore be diagnosed, and if possible the oil combustion in the engine should be limited as far as possible (and potentially it should also be determined which cylinder is affected so that the defective ring or rings can be repaired).

After an oil leak is detected or suspected in the engine, it is proposed herein to confirm that oil combustion is taking place in the engine. This is because there could be an oil leak without any combustion of the leaking oil. Then, the amount of oil being burned in the engine can be quantified and action can be taken as a function of how much oil is being taken in to one or more of the combustion chambers.

There are several methods for detecting an oil leak. Such a leak can for example be determined simply by monitoring the oil level in an oil sump of said engine. Generally, if the oil level drops, the missing oil is burned in the engine, but it is also possible that the missing oil is seeping out around a seal between the engine block and the outside.

In order to confirm that oil is being burned in the engine, the idea is to monitor the behavior of the engine when the fuel supply to the engine is cut off. This is the case in particular when a driver of the vehicle lifts their foot off the accelerator pedal of the vehicle. The vehicle then decelerates. However, if there is suction of oil into a combustion chamber, this oil will be burned, produce torque at the engine output, and therefore influence the behavior of the engine, in particular its deceleration.

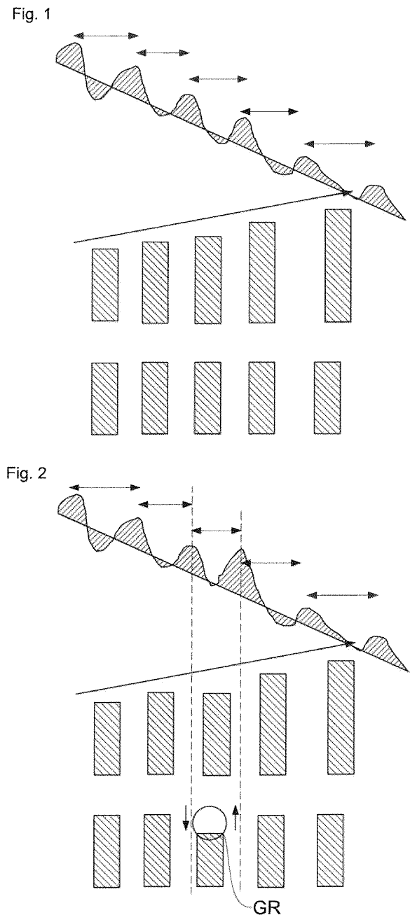

FIGS. 1 and 2 illustrate a step of confirming combustion of oil in an engine, here a four-cylinder engine. FIG. 1 acts as a reference and shows the behavior of an engine without suction of oil, and FIG. 2 is similar to FIG. 1 but for an engine in which there is suction of oil into a combustion chamber.

FIG. 1 illustrates a curve showing the variation in speed of rotation of the engine. This speed of rotation oscillates around a line the slope of which corresponds to the mean deceleration of the speed of rotation of the engine.

Below the speed curve, bars are shown the height of which is proportional to the duration (in seconds(s) or milliseconds (ms)) of the time interval separating the passes of a piston of the engine through a predetermined point of a cycle of the engine. On the curve illustrating the variation in the speed of rotation of the engine, a double-ended arrow has been used to mark an interval corresponding to two successive passes through a relative maximum speed, which corresponds to a pass through bottom dead center after combustion. Other passage points can be selected, such as for example top dead center at the end of an air compression phase in the corresponding cylinder (therefore corresponding to minimum rotation speeds).

The height of the bars corresponds to the length of the double-ended arrows. Because the engine is in a deceleration phase, the size of the bars increases.

In order to compare the size of the bars more easily, provision is advantageously made to correct their size in order to take into account the mean deceleration of the engine (vehicle). In FIG. 1, although it is a four-cylinder engine, five bars are shown. The first and the last correspond to one and the same cylinder. The measurements taken for one and the same cylinder can be compared as they are taken in similar conditions (similar relative position of a sensor and a target used to determine the angular position and speed of the engine). If for example the height of the first bar is X and the height of the fifth bar (which corresponds to the same cylinder) is X+4, and if the deceleration is constant, the height of the second bar should thus be X+1, the height of the third bar X+2, and the height of the fourth bar X+3. By removing 1, 2, 3, and 4 respectively from the height of the 2nd, 3rd, 4th, and 5th bars, a constant height of the bars (X) is obtained, as illustrated at the bottom of FIG. 1.

If then, as illustrated in FIG. 2, the bars are not the same size after correction, to within measurement uncertainties, and one bar stands out for example due to a smaller height, then it can be deduced that oil is being burned in the corresponding cylinder, because it means that the time elapsed between two successive top dead centers corresponding to one cylinder is shorter; it can be assumed that an acceleration due to uncontrolled combustion is behind this height difference.

In an equivalent manner, instead of subtracting a value from the duration of a time interval, a correction factor can be applied to each measurement of the time elapsed between two passes through successive top dead centers.

Let N be the number of cylinders.

Let n be the number of a time interval between two successive passes through top dead centers at the end of compression, where n equals 1, 2, . . . , N.

Let T_Seg_Mes_n be the duration of the time interval n.

Let Rn be the factor to be applied to an interval duration in order to obtain a corrected interval duration T_Corr_Seg_Mes_n=Rn*T_Seg_Mes_n.

In an equivalent (and generalized) manner to the above, the following will be obtained:

$$Rn = ( [ ( T\_Seg \_Mes \_n - T\_Seg \_Mes \_ 1 ) / T\_Seg \_Mes \_ 1 ] - Dec\_Corr$$

where Dec_Corr=[n/N]*[(T_Seg_Mes_(1−N)−T_Seg_Mes_1)/T_Seg_Mes_1]

Here, the measurement T_Seg_Mes_(1−N) is considered to correspond to the measurement taken in the preceding cycle for interval 1.

The number 1 can be arbitrarily assigned to an interval. It will be noted that each interval can be associated with a cylinder. If oil combustion is taking place in a cylinder, it will essentially influence the duration of the time interval starting when the piston of said cylinder is at top dead center at the end of compression.

In order to determine if a corrected value (T_Corr_Seg_Mes_n) is less than the other corrected values, this corrected value T_Corr_Seg_Mes_n can for example be compared with the mean of all of the corrected values with n varying from 1 to N. If for example an interval duration T_Corr_Seg_Mes_n is less than 97%, or 95%, or 90%, of the mean duration of the intervals measured on the corresponding cycle, then the interval n is considered to have a shorter duration and to correspond to oil combustion.

Instead of taking the mean of N interval durations, T_Corr_Seg_Mes_n can be compared to the mean of the (N−1) largest corrected values. If then T_Corr_Seg_Mes_n is less than 95% or 90% for example, of this other mean value, oil combustion can be considered to have occurred in the corresponding cylinder.

The results of this confirmation step are stored as they can be used to determine the quantity of oil that has been burned.

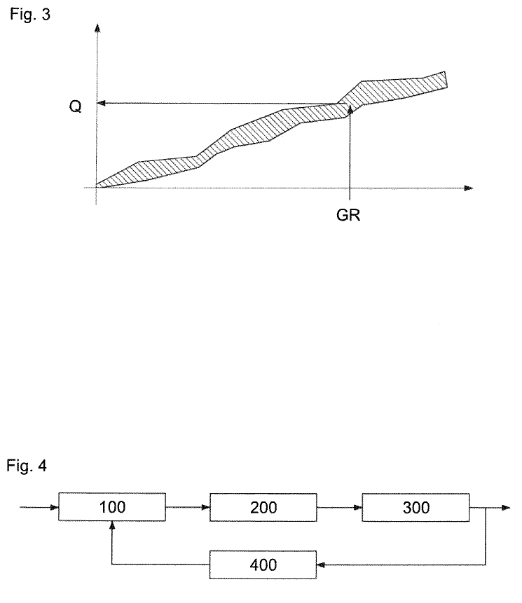

FIG. 3 illustrates a step making it possible to determine the quantity of oil burned, or at the very least to qualify it. The graph shown in FIG. 3 is stored in an electronic unit of the engine. For the engine in question, during tuning, tests are carried out to observe the influence of the injection of a known quantity of fuel into a cylinder. With a new engine, deceleration conditions are reproduced and a known quantity of fuel, for example 1 mg, then 2 mg, etc., is injected into and burned in a cylinder. The behavior of the engine is then observed as explained above: the time between top dead centers at the end of compression is observed, the durations elapsed between two passes through top dead centers at the end of compression are corrected, and the behavior in the cylinder in question is observed. A gradient GR of the corrected duration is then noted, as illustrated in FIG. 2. On the basis of the tests carried out on a new engine, a graph such as the one in FIG. 3 is produced and stored. In FIG. 3, the x-axis shows a time gradient (as illustrated in FIG. 2), while the y-axis shows a quantity of fuel. An equivalence between a quantity of fuel and a quantity of oil can be established. The oil burned in a cylinder can also be quantified not in grams of oil, but in “fuel equivalent grams”. There can be several graphs such as the one in FIG. 3, for example for different engine speeds.

On the basis of the measurements taken to confirm that oil combustion has occurred, the corrected duration gradient GR is therefore determined, found as illustrated in FIG. 2. This gradient value GR is then introduced into the graph in FIG. 3 and gives a quantity of oil burned Q (or fuel equivalent). This quantity can for example be a quantity of oil per engine cycle.

In a novel manner, the method according to the present disclosure comprises a step for eliminating, or at least limiting, the suction of oil that has been quantified.

FIG. 4 shows the step 100 of confirming oil combustion in the engine, together with the next step described above, which is a step 200 of determining the quantity of oil consumed. To prevent oil from being burned in the combustion chamber, oil must be prevented from entering said combustion chamber. This happens when the pressure prevailing in the combustion chamber is less than the pressure prevailing in the sump containing the engine lubricating oil. In order to limit the quantity of oil entering the combustion chambers, the pressure in said chambers must thus be increased when possible. It will be noted that in the deceleration phase, the air intake into the cylinders is limited. As a result, the air pressure is limited. Measurements taken in the cylinders show that the pressure in a combustion chamber can fall to values of the order of 800 mbar (80 kPa). It is then possible to take action to increase this pressure. There are several means available here. The means that exists on (almost) all engines consists in opening a butterfly valve that makes it possible to regulate the air flow entering the engine. In the deceleration phase, this butterfly valve is generally closed, and the pressure in the cylinders is then minimal. By opening this valve, the air pressure in the cylinders in the deceleration phase therefore increases.

There are also other means for acting on the pressure inside the combustion chambers (in the absence of combustion). In some engines, provided with a turbocharger (or other compressor), the air introduced into the engine can be compressed before entering the combustion chambers. By acting on the turbocharger, the pressure in the combustion chambers can be increased. Another means is to act on an exhaust gas recirculation valve (EGR valve). By injecting air leaving the engine back into the intake, it is possible to increase the intake air pressure and therefore the air pressure in the combustion chambers.

In FIG. 4, a command step 300 is thus provided in order to increase the air pressure in the combustion chambers. This command step 300 is thus for example a step of commanding the opening of the butterfly valve of the engine. This command step 300 then results in an increase in the pressure in the cylinders. This then results in a variation 400 in the quantity of oil entering the cylinder that has a sealing problem.

A regulation loop is proposed in order to check that the measures taken (variation in the opening of the butterfly valve or other) are effective and the step 100 of confirming the quantity of oil consumed is repeated.

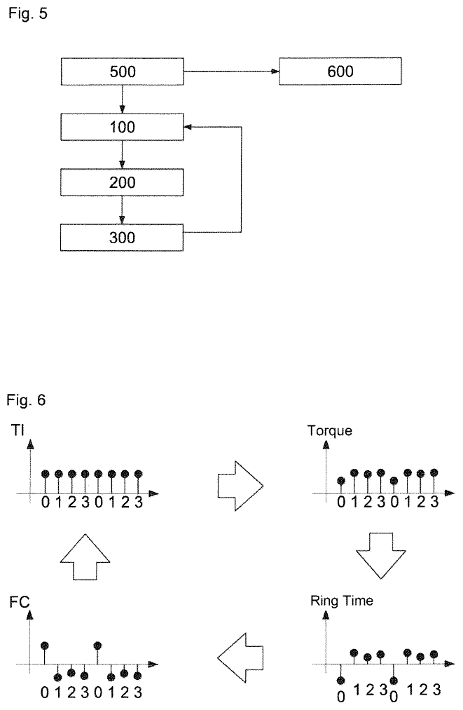

FIG. 5 is a logic diagram summarizing an embodiment of a method according to the present disclosure. This method relates to the management of an internal combustion engine in particular when oil is being burned (in an unintentional and uncontrolled manner) in one or more combustion chambers. When the internal combustion engine is new, fuel injectors are mounted in the engine and they all have substantially the same characteristics so that for one and the same injection setpoint, they all inject one and the same quantity of fuel. When the engine ages, oil (for lubrication) can enter one or more combustion chambers and be burned. When it burns, this oil generates unexpected additional torque. The method in FIG. 5 aims to reduce the quantity of oil entering (sucked into) a combustion chamber and any risk of damage to the engine when the oil suction (or uncontrolled oil combustion) phenomenon is detected.

This method is thus implemented when an oil leak (or oil consumption) is detected during a detection step 500, here incorporated into FIG. 5. This detection can take place in a variety of ways.

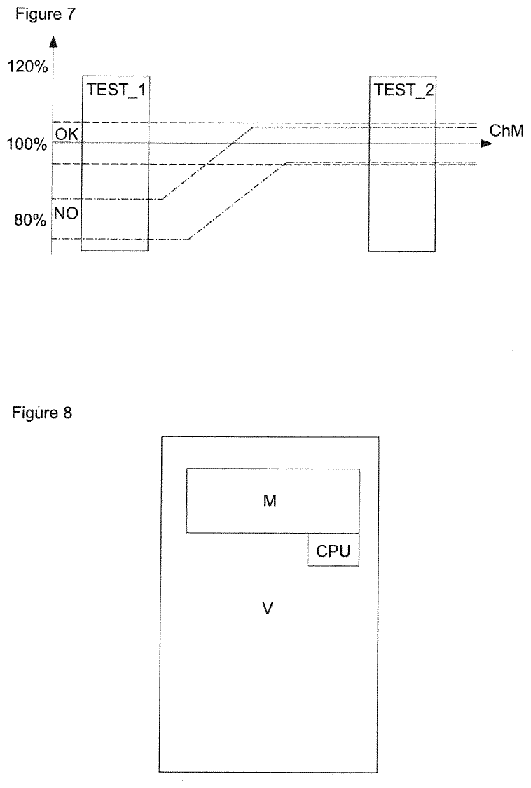

It is proposed below (with reference to FIGS. 6 and 7) to observe how the engine behaves from a stability viewpoint when it is new, and then to periodically observe the behavior of the engine in order to compare it to its initial behavior, that is, the behavior of the new engine.

Once oil consumption has been found, it is proposed to observe (or confirm) that the oil consumed is being (fully or partially) burned in a combustion chamber of the engine. This confirmation step 100 is carried out when the engine is operating in a phase during which no fuel combustion is commanded. The calculations carried out during this step are based on the analysis of the time elapsed between two successive passes of the pistons of the engine through top dead centers at the end of compression (that is, before potential combustion). These time measurements are carried out using a crankshaft sensor that interacts, as known to a person skilled in the art, with a toothed target rigidly connected to the crankshaft, this system making it possible in particular to determine the angular position and speed of rotation of the engine. During this step, no fuel is injected into the cylinders and the only combustions are the potential, uncommanded, combustions of oil. This measurement phase using the crankshaft sensor is for example carried out during a deceleration phase, when the driver of the vehicle lifts their foot off the accelerator pedal. As explained above, the measured times are corrected by a correction factor (addition and/or multiplication) in order to take into account the deceleration of the engine (vehicle). If there is no combustion, the corrected measured times are substantially the same. Otherwise, it is deduced from the measurements that there has been at least one uncontrolled combustion. In this case, one corrected measured time is shorter than the others.

The oil burned is quantified during the determination step 200. As stated, one corrected measured duration is shorter than the others. As a function of the difference (gradient) between the other corrected measurements and the shortest measurement, the quantity of oil burned can be estimated using a map produced in advance on a new engine of the same type.

A command step 300 is sent to a member of the engine in order to increase the pressure of the air entering the cylinders. This command is sent to an air flow butterfly valve and/or a turbocharger valve and/or an exhaust gas recirculation valve.

A return to the confirmation step is then provided in order to check that the command making it possible to limit the suction of oil into a combustion chamber has been effective.

An example of detection (step 500) is proposed here as set out above with reference to FIGS. 6 and 7. This involves determining the behavior of the engine in terms of stability, or regularity, by observing whether over a complete cycle (two crankshaft revolutions), the passes through the top dead centers corresponding to combustion (that is, at the end of compression) take place at the expected instant, or before it, or indeed after it. For example, for a four-cylinder in-line engine, the times between two successive passes through top dead center are ideally constant.

The stability of the engine is then observed when the load on the engine is low and when it is high. This observation is made for the first time when the engine is new and is then used as a basis for comparison. Then, periodically, an observation is made and if the behavior of the engine varies, an analysis is carried out to determine whether this variation is due to suction of oil into a combustion chamber.

FIG. 6 shows an observation of the operating stability of the engine and the analysis thereof in order to make a diagnosis.

The operating stability of the engine is observed at a predetermined operating point. In some observations, the operating point corresponds to a low load, for example when the torque required is less than 20% of the maximum torque available, or less than 15% of this maximum torque, or even less than 10% of this maximum torque. The low-load operating point can for example also correspond to the engine idling. In other observations, the operating point corresponds to a high load, for example when the torque required is greater than 50% of the maximum torque available, or greater than 60% of this maximum torque, or even greater than 70% of this maximum torque.

In the case under considered here, which corresponds to a four-cylinder in-line engine, a reference rotation time is measured, necessary for the crankshaft to perform a rotation of 180° C. RK. As known to a person skilled in the art, this 180° rotation time, or reference time, can be measured using a toothed wheel, also known as a target, fastened to the crankshaft and having at least one angle marker. A position sensor associated with the toothed wheel (target) detects the passes of the angle marker or markers and each tooth. On each pass, the position sensor emits an electrical signal and the reference time is determined using these electrical signals.

For a “stable” engine, the steady-state reference times remain constant over an engine cycle.

The top left-hand diagram in FIG. 1 corresponds to a torque setpoint TI over an operating range for two cycles (that is, 1440° C. RK=2*720° C. RK) and the torque requests are numbered from 0 and 3 and are substantially constant.

Fuel is injected into each cylinder as a function of the torque request TI. Since this request is constant, provision is made to inject one and the same quantity of fuel into each cylinder. Whether or not the engine is new, manufacturing tolerances (injectors or engine machining) or tolerances relating to the homogeneity of the fuel mean that the torque produced (Torque) is different from the torque setpoint TI. The top right-hand diagram in FIG. 1 illustrates the actual torque supplied by each of the combustions in the engine. It will be noted that in this example, this torque is not constant. The combustions numbered 1 to 3 supply substantially similar torque but the torque supplied by the combustion numbered 0 is less than the torque corresponding to combustions 1 to 3.

The reference time represents the torque supplied by the combustion that occurs over the corresponding angular range of rotation of the engine. If the torque supplied by one combustion is higher, then the corresponding reference time will be shorter, and vice versa. In the preceding example corresponding to FIG. 1, the reference time corresponding to the combustion numbered 0 will thus be less than the reference time for the other combustions 1 to 3. The bottom right-hand diagram in FIG. 1 shows the reference times relative to a mean reference time corresponding to the speed of rotation of the engine. If rpm is the speed of rotation of the engine in revolutions per minute, the mean reference time is then, in seconds, 30/rpm, i.e. 30 ms for a speed of rotation of 1,000 rpm. The reference time for combustion 0 is thus less than the mean reference time corresponding to the speed of rotation of the engine, while the reference times for combustions 1 to 3 are greater than the mean reference time.

As shown in the bottom right-hand diagram in FIG. 1, there is variability between the measured reference times. In order to obtain a substantially equal reference time corresponding to a rotation of 180° C. RK for each combustion/cylinder, a reference fuel injection correction factor FC is determined for each cylinder so as to obtain a sum of correction factors equal to N, N being the number of cylinders of the engine in question. Regulation based on the reference times makes it possible to iteratively determine the various correction factors. The bottom left-hand diagram in FIG. 1 shows the correction factors for the cylinders (the x-axis corresponds to value 1). For example, there is FC0 for cylinder 0 corresponding to combustion 0, equal to 1.10, FC1 and FC3 for cylinders 1 and 3 corresponding to combustions 1 and 3, equal to 0.96, and FC2 for cylinder 2 corresponding to combustion 2, equal to 0.98. In this example, the reference correction factor brings all of the reference times, in the case of equivalent combustion, to the same value for a 180° rotation of the crankshaft. The engine management system then regulates the quantity of fuel introduced into each cylinder so as to obtain reference times that are equal, to within the reference correction factor. The quantity of fuel introduced into each cylinder thus differs by a reference correction factor FCn with respect to the quantity of fuel that should have been introduced if the regulation had not been applied.

Here, the detection comprises a first step, which is a learning step. The engine is new, or almost new, and the aim of this step is to establish the characteristics of the engine before any wear occurs. The stability of the engine is monitored at least once when the engine is under low load and at least once when the engine is under high load. The engine load ChM is for example determined by comparing the torque required by the engine management system and the maximum torque that the engine can deliver. The engine load is considered to be low, for example, if the torque required is less than 20% of the maximum torque available, or 15% of the maximum torque available, or 10% of the maximum torque available. Preferably, the stability of the engine is monitored when the engine is warm and the oil used for lubricating the engine is at nominal pressure. The engine load ChM is considered to be high, for example, if the torque required is greater than 50% of the maximum torque available, or 60% of the maximum torque available, or 75% of the maximum torque available.

As explained above, the stability monitoring step consists in measuring the reference times when the conditions corresponding to a predetermined operating point (low load or high load) have been reached and have stabilized. On the basis of these reference time measurements for all of the cylinders (combustions) over one or more cycles, correction factors (one factor for each cylinder) are determined, as explained above with reference to FIG. 6. These correction factors are then stored, for example in a memory of the engine management system.

This stability monitoring step can for example be performed two or three times in order to confirm the results found. The results can be filtered.

At the end of this learning step, a correction factor for each cylinder for low-load operation and a correction factor for each cylinder for high-load operation have been stored (that is, 2N values stored).

A waiting step is then proposed. This is because provision is made to monitor the stability of the operation of the engine periodically. This period can correspond to a time (for example in days or months) or to a mileage. During this waiting step, provided that the value of the variable (time or mileage) is less than a predetermined value Thn, the system will continue to wait. When the value of the variable has been reached, a second (or nth) stability monitoring step is carried out: reference times are measured, at low load and high load, and correction factors are determined and stored. At the end of this second (or nth) step, new correction factor values are stored. Of course, as for the learning step, these stored values are preferably confirmed by at least another step of monitoring the stability of the engine for the same (or a similar) operating point.

Once a new set of correction factor values (with 2N values) has been stored, a determination step is triggered. Here, the new correction factors are compared to the correction factors obtained during the first learning step. It seems clear that if the correction factors have not changed (or have only slightly changed), then all is well and no suction is detected.

Here, suction is detected if a correction factor corresponding to the stability monitoring at low load has decreased while the correction factor corresponding to the same cylinder at high load has not changed (or has only slightly changed); suction is then detected on the cylinder corresponding to the correction factor that has changed. Here, a threshold is predetermined, for example 0.9 or 90%, relating to the correction factor measured at low load. An interval is also predefined at high load. For example, the correction factor is considered to vary slightly if it only varies by less than 5%. This gives a range from 95% to 105%. Thus in the preceding example, if the correction factor obtained for a cylinder becomes less than 90% of the correction factor stored at the end of learning at low load for the same cylinder and the new correction factor at high load for this cylinder is between 95% and 105% of the value of the high-load correction factor stored at the end of the first learning step, then the management system considers that there is suction into the corresponding cylinder. The method therefore makes it possible not only to detect a suction of oil, but also to obtain information relating to the cylinder affected (or the piston on which at least one of the rings is defective). The above method might also reveal that more than one cylinder is affected.

According to one detection variant, the variation at high load can also be observed. It is assumed that for a given cylinder the high-load correction factor changes from 1.00 to 0.98, that is a ratio between the correction factor in the detection step and the correction factor in the learning step of 0.98. It is then considered that there is suction of oil into the cylinder in question if the ratio between the correction factor in the detection step and the correction factor in the learning step at low load is less than (0.98−y), where y is for example predetermined as a function of the engine characteristics in particular. By way of illustrative, non-limiting example, y is for example in the interval [0.1; 0.2].

A warning step 600 (FIG. 5) can then be triggered. A message is then displayed for example on a dashboard of the corresponding vehicle, or an indicator light comes on. The method above also makes it possible to indicate which cylinder (piston) is affected. This information is not necessarily accessible on the dashboard of the vehicle, but it will be accessible to the motor mechanic in charge of repairing the engine and eliminating the leak. However, statistically, there is little chance that two rings of two different pistons will wear in parallel and that the oil leaks will occur (and be detected) one after the other.

If no suction is detected, then a new limit Thn+1 that replaces the previous limit Thn is implemented, and the method returns to the waiting step.

FIG. 7 summarizes the detection method described above in a diagram.

In FIG. 7, the x-axis corresponds to the engine load and the y-axis corresponds to a proportion between a correction factor obtained in the learning step and a correction factor obtained subsequently.

The first window (TEST_1) shows the operating points for monitoring the stability at low load, while the second window (TEST_2) shows the operating points for monitoring the stability at high load. The monitoring at low load is thus for example performed when the engine load is between 10 and 25% of the maximum load of the engine, while monitoring at high load is for example performed when the engine load is between 50 and 80% of the maximum load of the engine.

If the ratio is determined between the correction factor obtained subsequently and the corresponding correction factor obtained during the learning step, at low load and at high load, and these ratios are in between the two dashed lines, then no suction is detected. Everything is in order (OK). If these ratios are between the two chain-dotted lines, then suction of oil is detected (NO) and a problem must be indicated.

This method is implemented by an electronic unit on board a vehicle, for example a motor vehicle. This electronic unit can be referred to as the management unit or control unit and is also known as the CPU. FIG. 8 schematically illustrates a vehicle V powered by an engine M, said engine being electronically managed by at least one electronic unit CPU.

### INDUSTRIAL APPLICABILITY

The present technical solution can be applied in particular to engine control for limiting the uncontrolled emissions of the engine, here due to the combustion of lubricating oil.

The proposed method, and the corresponding means for implementing this method, also optionally make it possible to indicate in which cylinder or cylinders of the engine suction of oil has been detected. It is therefore possible to take targeted action on the cause of the suction of oil in order to bring it to an end.

The present disclosure is not limited to the proposed embodiments and to the variants described above, which are provided solely by way of example, but encompasses all of the variants that could be envisaged by a person skilled in the art within the scope of the protection sought.

1. A method for limiting a suction of oil into an internal combustion engine comprising a plurality of cylinders in each of which a piston slides, following the detection of the presence of said suction of oil, characterized in that it comprises the following steps:
a step (100) of confirming the presence of suction, performed in the absence of fuel combustion, with the following sub-steps:
a) monitoring by measuring durations of time intervals (T_Seg_Mes_n) between two successive passes through top dead center at the end of compression by the pistons in the cylinders,
b) applying a deceleration correction factor (Rn) to be applied to the measured interval duration, for each time interval, in order to take into account a mean deceleration of the engine speed,
c) comparing the measured and corrected interval durations (T_Corr_Seg_Mes_n), and
d) potentially detecting one (or more) measured and corrected interval duration(s) less than the other measured and correct interval durations, and storing the result of the detection,
a step (200) of determining a quantity of oil burned in the engine if in the preceding confirmation step (100) at least one measured and corrected interval duration (T_Corr_Seg_Mes_n) less than the others has been detected, with the following sub-steps:
e) determining a gradient (GR) representing a variation in speed of rotation of the engine, and
f) on the basis of said gradient, estimating the quantity of oil burned (Q) using a predetermined, stored map,
if applicable, a step (300) of adapting the intake air pressure in the cylinders, during which a variation in said pressure is commanded as a function of the previously determined quantity of oil burned.

2. The method as claimed in claim 1, characterized in that the deceleration correction factor (Rn) to be applied in sub-step b) is determined as a function of the variation in the duration of a time interval from one cycle to another for a cylinder, and of the number of cylinders in the engine.

3. The method as claimed in claim 1- or 2, characterized in that the gradient (GR) representing a variation in speed of rotation of the engine in sub-step e) is a gradient of variation in the duration of the measured and corrected time interval less than the other durations of measured and corrected time intervals.

4. The method as claimed in claim 1, characterized in that the map in sub-step f) is produced in advance on an engine of the same type not experiencing suction of oil, in which in a deceleration phase for which no combustion is envisaged, known quantities of fuel per engine cycle are injected and burned at various engine speeds and the influence of this injection and this combustion on the gradient used in step e) is measured.

5. The method as claimed in claim 1, characterized in that during the adaptation step (300), the variation in the intake air pressure in the cylinders is commanded by acting on at least one of the following elements of the engine:
air intake butterfly valve, and/or
turbocharger, and/or
exhaust gas recirculation valve.

6. The method as claimed in claim 1, characterized in that it also comprises a prior step (500) of detecting oil combustion and a step of determining a cylinder in which said oil combustion is taking place.

7. The method as claimed in claim 6, characterized in that it comprises the following steps for detecting the presence of suction of oil:
a detection step carried out with the following sub-steps:
i) a first step of monitoring the operating stability of the engine at a first low-load operating point,
ii) a first step of determining a respective correction factor to be applied, for each cylinder, in order to correct a quantity of fuel injected into said cylinder, with a view to regulating the engine speed at said first operating point,
iii) a first step of storing the respective correction factors for each cylinder, corresponding to the first operating point,
iv) a second step of monitoring the operating stability of the engine at a second high-load operating point,
v) a second step of determining a respective correction factor to be applied, for each cylinder, in order to correct a quantity of fuel injected into said cylinder, with a view to regulating the engine speed at said second operating point,
vi) a second step of storing the respective correction factors for each cylinder, corresponding to the second operating point,
a step of determining oil combustion in a given cylinder if, for said cylinder, the ratio between a first predetermined correction factor and the correction factor corresponding to the first operating point during the detection step is below a predetermined threshold, while for the same cylinder the ratio between a second predetermined correction factor and the correction factor corresponding to the second operating point during the detection step is within a predetermined interval around 1.

8. The method as claimed in claim 1, characterized in that it further comprises a warning step (600) when suction of oil is detected.

9. A computer program comprising instructions which, when the program is executed by a computer, cause the computer to implement all of the steps of a method as claimed in claim 1.

10. A control unit configured for managing an internal combustion engine, characterized in that it comprises means for implementing each of the steps of a method as claimed in claim 1.

11. A motor vehicle comprising an internal combustion engine, characterized in that it comprises a control unit as claimed in claim 10.
